(19) United States
(12) Patent Application Publication
(10) Pub. No.: US 2002/0089596 A1
(43) Pub. Date: Jul. 11, 2002

(54) Image sensing apparatus

(76) Inventor: Yasuo Suda, Kanagawa (JP)

Correspondence Address: MORGAN & FINNEGAN, L.L.P., 345 PARK AVENUE, NEW YORK, NY, 10154, US

(21) Appl. No.: 10/033,083

(22) Filed: Dec. 27, 2001

(30) Foreign Application Priority Data
Dec. 28, 2000 (JP) 403272/2000(PAT.)

(51) Int. Cl. H04N 3/14; H04N 5/335

(52) U.S. Cl. 348/302

(57) ABSTRACT

It is an object of this invention to provide an image sensing apparatus capable of forming a high-resolution image by increasing the number of final output pixels. To achieve this object, a digital color camera has a plurality of image sensing units for receiving object images via different apertures. These image sensing units are so arranged that images of an object at a predetermined distance are received as they are shifted a predetermined amount from each other in at least the vertical direction. Further, these image sensing units have filters having different spectral transmittance characteristics.

### FIELD OF THE INVENTION

The present invention relates to an image sensing apparatus, such as a digital electronic still camera or a video movie camera, using a solid-state image sensor.

### BACKGROUND OF THE INVENTION

In a digital color camera, a solid-state image sensor such as a CCD or a MOS sensor is exposed for a desired time to an object image in response to the pressing of a release button. An image signal indicating the obtained image of one frame is converted into a digital signal and subjected to predetermined processing such as YC processing, thereby acquiring an image signal of a predetermined format. Digital signals representing the sensed images are recorded in a semiconductor memory in units of images. The recorded image signals are independently or successively read out at any time, reproduced into signals which can be displayed or printed, and displayed on a monitor or the like.

The present applicant formerly proposed a technique by which RGB images are generated by using a three- or four-lens optical system and synthesized to form a video signal. This technique is extremely effective in realizing a thin-profile image sensing system.

Unfortunately, the above technique has two problems. The first problem is that it is difficult to use general-purpose signal processing technologies corresponding to a solid-state image sensor having a Bayer arrangement. The second problem is that a technology which increases the number of final output pixels to thereby obtain high-resolution images is still undeveloped.

### SUMMARY OF THE INVENTION

The present invention has been made in consideration of the above problems, and has as its object to provide an image sensing apparatus for sensing a plurality of color-separated images and synthesizing these images to obtain a color image, which can increase the number of final output pixels to obtain high-resolution images.

To solve the above problems and achieve the object, an image sensing apparatus according to the present invention is characterized by the following arrangement.

That is, an image sensing apparatus comprises a plurality of image sensing units for receiving an object image via different apertures, wherein the plurality of image sensing units are arranged such that images of an object at a predetermined distance are received as they are shifted a predetermined amount from each other in at least the vertical direction, and wherein said plurality of image sensing units have filters having different spectral transmittance characteristics.

Other objects and advantages besides those discussed above shall be apparent to those skilled in the art from the description of a preferred embodiment of the invention which follows. In the description, reference is made to accompanying drawings, which form a part hereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a front view of an image sensing apparatus according to the first embodiment of the present invention;

FIG. 2 is a side view of the image sensing apparatus viewed from the left with reference to the rear surface of the image sensing apparatus;

FIG. 3 is a side view of the image sensing apparatus viewed from the right with reference to the rear surface of the image sensing apparatus;

FIG. 4 is a sectional view of a digital color camera, taken along a plane passing a release button, image sensing system, and finder eyepiece window;

FIG. 5 is a view showing details of the arrangement of the image sensing system;

FIG. 6 is a view showing a taking lens viewed from the light exit side;

FIG. 7 is a plan view of a stop;

FIG. 8 is a sectional view of the taking lens;

FIG. 9 is a front view of a solid-state image sensor;

FIG. 10 is a view showing the taking lens viewed from the light incident side;

FIG. 11 is a graph showing the spectral transmittance characteristics of optical filters;

FIG. 12 is a view for explaining the function of microlenses 821;

FIG. 13 is a view for explaining the setting of the spacing between lens portions 800a and 800d of a taking lens 800;

FIG. 14 is a view showing the positional relationship between object images and image sensing regions;

FIG. 15 is a view showing the positional relationship between pixels when image sensing regions are projected onto an object;

FIG. 16 is a perspective view of first and second prisms 112 and 113 constructing a finder;

FIG. 17 is a block diagram of a signal processing system;

FIG. 18 is a view showing addresses of image signals from image sensing regions 820a, 820b, 820c, and 820d;

FIG. 19 is a view for explaining signal read from an image sensor having a Bayer type color filter arrangement;

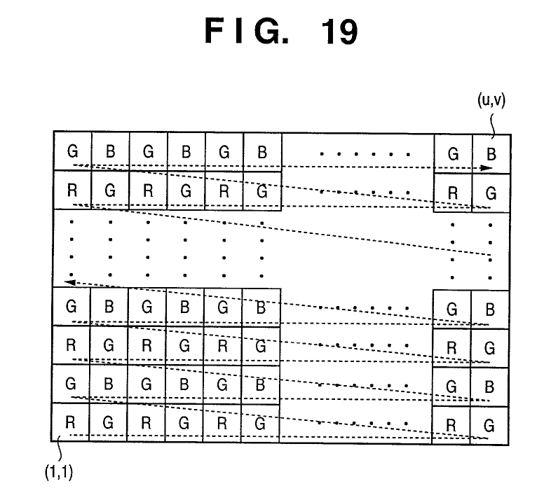

FIG. 20 is a view showing another example of the positional relationship between object images and image sensing regions; and

FIG. 21 is a view showing still another example of the positional relationship between object images and image sensing regions.

### DETAILED DESCRIPTION OF THE PREFERRED EMBODIMENTS

Preferred embodiments of the present invention will now be described in detail in accordance with the accompanying drawings.

(First Embodiment)

An image sensing apparatus according to the first embodiment of the present invention is characterized by being equivalent to a camera system using an image sensor having a Bayer type color filter arrangement, in respect of the spatial sampling characteristics of an image sensing system and the time-series sequence of sensor output signals.

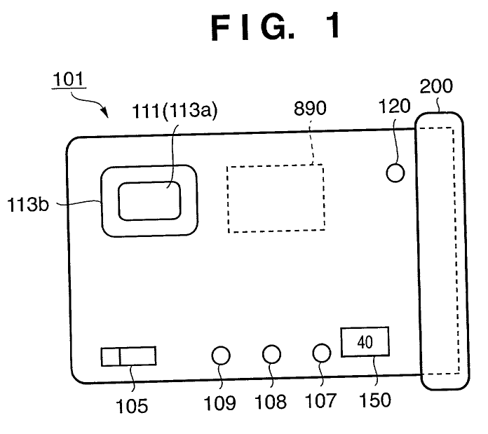

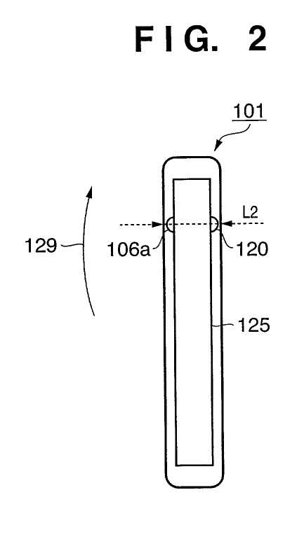

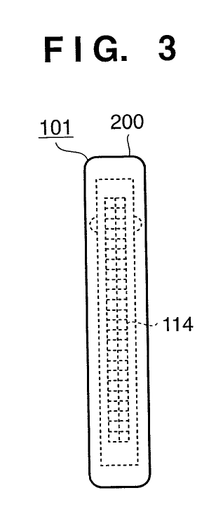

FIG. 1 is a front view of the image sensing apparatus according to the first embodiment of the present invention. FIG. 2 is a side view of the image sensing apparatus viewed from the left with respect to the rear surface of the image sensing apparatus. FIG. 3 is a side view of the image sensing apparatus viewed from the right with respect to the rear surface of the image sensing apparatus.

The image sensing apparatus according to the first embodiment of the present invention is a digital color camera 101. This digital color camera 101 includes a main switch 105, a release button 106, switches 107, 108, and 109 by which the user sets the status of the digital color camera 101, a finder eyepiece window 111 through which object light entering the finder exits, a standardized connecting terminal 114 for connecting to an external computer or the like to exchange data, a projection 120 formed coaxially with the release button 106 on the front surface of the digital color camera 101, and a display unit 150 which displays the number of remaining frames.

In addition, the digital color camera 101 includes a contact protection cap 200 which is made of a soft resin or rubber and which also functions as a grip, and an image sensing system 890 placed inside the digital color camera 101.

Note that the digital color camera 101 can also be so made as to have the same size as a PC card and inserted into a personal computer. When this is the case, the dimensions of the digital color camera 101 must be 85.6 mm in length, 54.0 mm in width, and 3.3 mm (PC card standard Type 1) or 5.0 mm (PC card standard Type 2) in thickness.

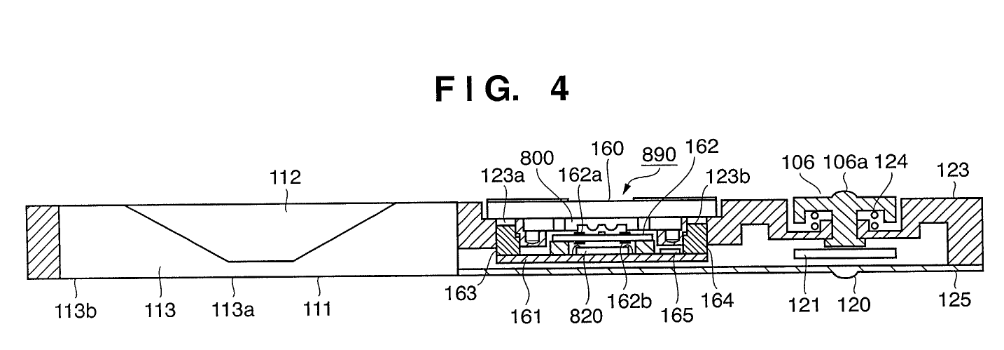

FIG. 4 is a sectional view of the digital color camera 101, taken along a plane passing the release button 106, the image sensing system 890, and the finder eyepiece window 111.

Referring to FIG. 4, reference numeral 123 denotes a housing for holding the individual constituent elements of the digital color camera 101; 125, a rear cover; 890, the image sensing system; 121, a switch which is turned on when the release button 106 is pressed; and 124, a coil spring which biases the release button 106 to protrude. The switch 121 has a first-stage circuit which is closed when the release button 106 is pressed halfway, and a second-stage circuit which is closed when the release button 106 is pressed to the limit.

Reference numerals 112 and 113 denote first and second prisms, respectively, forming a finder optical system. These first and second prisms 112 and 113 are made of a transparent material such as an acrylic resin and given the same refractive index. Also, the first and second prisms 112 and 113 are solid to allow rays to propagate straight.

A region 113b having light-shielding printing is formed around an object light exit surface 113a of the second prism 113. This region 113b limits the range of the passage of finder exit light. Also, as shown in FIG. 4, this printed region extends to portions opposing the side surfaces of the second prism 113 and the object light exit surface 113a.

The image sensing system 890 is constructed by attaching, to the housing 123, a protection glass plate 160, a taking lens 800, a sensor board 161, and joint members 163 and 164 for adjusting the sensor position. On the sensor board 161, a solid-state image sensor 820, a sensor cover glass plate 162, and a temperature sensor 165 are mounted. The joint members 163 and 164 movably fit in through holes 123a and 123b of the housing 123. After the positional relationship between the taking lens 800 and the solid-state image sensor 820 is appropriately adjusted, these joint members 163 and 164 are adhered to the sensor board 161 and the housing 123.

Furthermore, to minimize the amount of light which enters the solid-state image sensor 820 from outside the image sensing range, light-shielding printing is formed in regions except for effective portions of the protection glass plate 160 and the sensor cover glass plate 162. Reference numerals 162a and 162b shown in FIG. 4 denote these printed regions. An anti-reflection coat is formed in portions other than the printed regions in order to avoid the generation of ghost.

Details of the arrangement of the image sensing system 890 will be explained below.

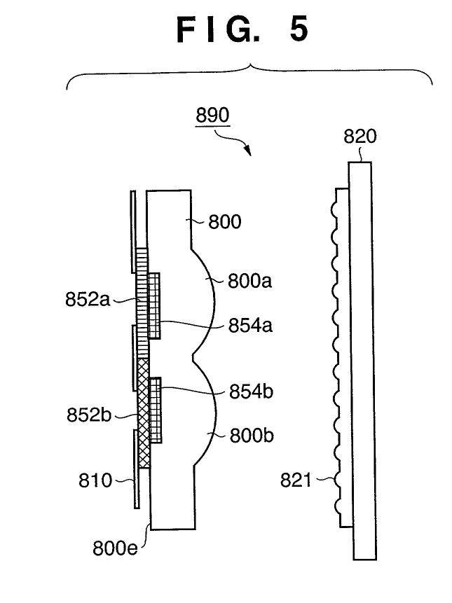

FIG. 5 is a view showing the arrangement of the image sensing system 890 in detail. The basic elements of an image sensing optical system are the taking lens 800, a stop 810, and the solid-state image sensor 820. The image sensing system 890 includes four optical systems to separately obtain image signals of green (G), red (R), and blue (B).

Note that a presumed object distance is a few meters, i.e., much longer than the optical path length of an image forming system. Therefore, assuming that the incident surface is aplanatic to the presumed object distance, this incident surface is a concave having a very small radius of curvature, so the incident surface is replaced with a plane surface.

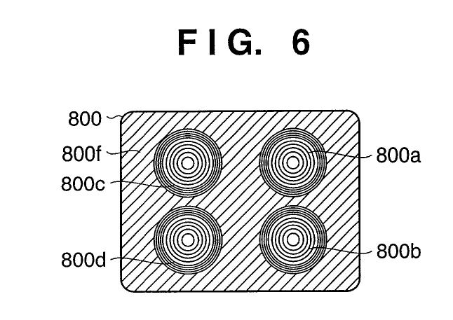

As shown in FIG. 6, the taking lens 800 viewed from the light exit side has four lens portions 800a, 800b, 800c, and 800d, each of which is formed by ring-like spherical surfaces. On these lens portions 800a, 800b, 800c, and 800d, an infrared cut filter given a low transmittance to a wavelength region of 670 nm or more is formed. Also, a light-shielding film is formed on a hatched plane surface portion 800f.

Each of the four lens portions 800a, 800b, 800c, and 800d is an image forming system. As will be described later, the lens portions 800a and 800d are used for a green (G) image signal, the lens portion 800b is used for a red (R) image signal, and the lens portion 800c is used for a blue (B) image signal. Note that all the focal lengths at the representative wavelengths of R, G, and B are 1.45 mm.

Referring back to FIG. 5, to suppress high-frequency components of an object image which are higher than the Nyquist rate determined by the pixel pitch of the solid-state image sensor 820 and which thereby increase the response of low frequencies, transmittance distribution regions 854a and 854b are formed on a light incident surface 800e of the taking lens 800. This is called apodization which is the method by which a desired MTF is obtained by maximizing the transmittance in the center of the stop and lowering the transmittance toward the perimeter.

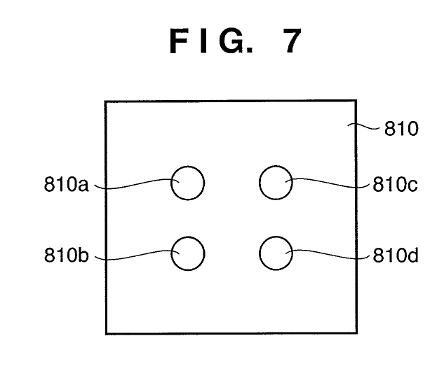

The stop 810 has four circular apertures 810a, 810b, 810c, and 810d as shown in FIG. 7. Object light incident on the light incident surface 800e of the taking lens 800 from these apertures exits from the four lens portions 800a, 800b, 800c, and 800d to form four object images on the image sensing surface of the solid-state image sensor 820. The stop 810, the light incident surface 800e, and the image sensing surface of the solid-state image sensor 820 are arranged parallel to each other (FIG. 5).

The stop 810 and the four lens portions 800a, 800b, 800c, and 800d are set to have a positional relationship meeting the conditions of Zincken-Sommer, i.e., a positional relationship by which coma and astigmatism are simultaneously removed.

Also, the curvature of field is well corrected by dividing the lens portions 800a, 800b, 800c, and 800d into rings. That is, an image surface formed by one spherical surface is a spherical surface represented by a Petzval curvature. An image surface is planarized by connecting a plurality of such spherical surfaces.

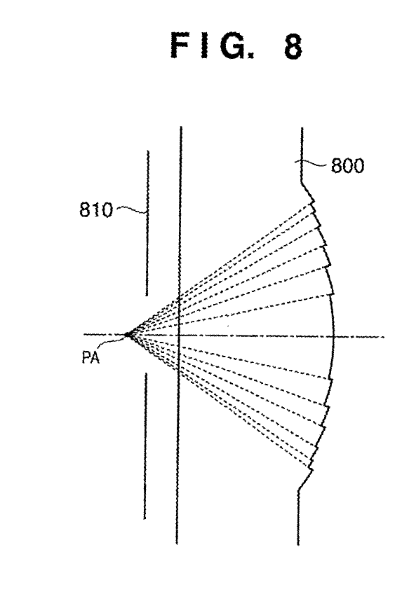

As shown in FIG. 8 which is a sectional view of each lens portion, central positions PA of the spherical surfaces of individual rings are the same in order to prevent the generation of coma and astigmatism. Furthermore, when the lens portions 800a, 800b, 800c, and 800d are thus divided, distortions of an object image produced by these rings are completely the same. Therefore, high MTF characteristics can be obtained as a whole. Remaining distortions are corrected by calculations. If distortions produced by the individual lens portions are the same, the correction process can be simplified.

The radius of the ring-like spherical surface is so set as to increase in arithmetic progression from the central ring to the perimeter. This increase amount is mλ/(n−1) where λ is the representative wavelength of an image formed by each lens portion, n is the refractive index of the taking lens 800 with respect to this representative wavelength, and m is a positive constant. When the radius of the ring-like spherical surface is thus set, the optical path length difference between rays which pass through adjacent rings is mλ, and the exit lights have the same phase. When each lens portion is divided into a larger number of portions to increase the number of rings, each ring functions as a diffraction optical element.

In order to minimize flare generated in the step of each ring, each ring has a step parallel to the principal ray as shown in FIG. 8. The flare suppressing effect obtained by this arrangement is large, since the lens portions 800a, 800b, 800c, and 800d are separated from the pupil.

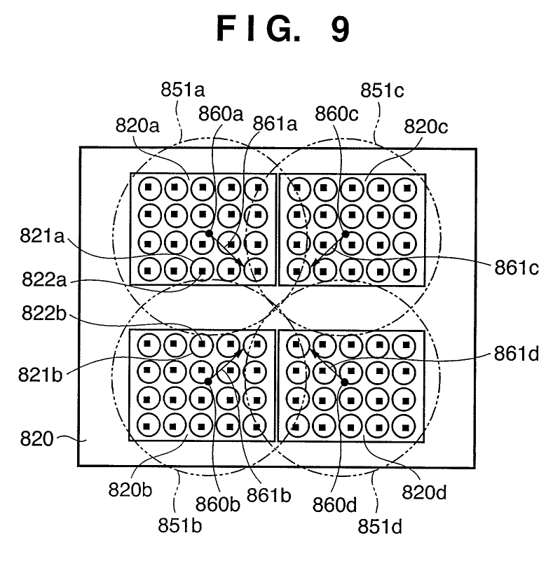

FIG. 9 is a front view of the solid-state image sensor 820. This solid-state image sensor 820 includes four image sensing regions 820a, 820b, 820c, and 820d on the same plane in accordance with four object images formed. Although they are simplified in FIG. 9, each of these image sensing regions 820a, 820b, 820c, and 820d is a 1.248 mm×0.936 mm region in which 800×600 pixels are arranged at a pitch P of 1.56 μm in both the vertical and horizontal directions. The diagonal dimension of each image sensing region is 1.56 mm. Between these image sensing regions, a separation band 0.156 mm in the horizontal direction and 0.468 mm in the vertical direction is formed. Accordingly, the distances between the centers of these image sensing regions are the same, 1.404 mm, in the vertical and horizontal directions. That is, assuming that a horizontal pitch a=P, a vertical pitch b=P, a constant c=900, and a positive integer h=1 in the image sensing regions 820a and 820d on the light receiving surface, these image sensing regions 820a and 820d are separated by a×h×c in the horizontal direction and b×c in the vertical direction. With this positional relationship, a misregistration produced in accordance with temperature changes or changes in the object distance can be corrected by very simple calculations. A misregistration is an object image sampling position mismatch produced between image sensing systems, such as R, G, and B image sensing systems, having different light receiving spectral distributions in, e.g., a multi-sensor color camera.

Reference numerals 851a, 851b, 851c, and 851d in FIG. 9 denote image circles in which object images are formed. A maximum shape of these image circles 851a, 851b, 851c, and 851d is a circle which is determined by the size of the aperture of the stop and the size of the exit-side spherical portion of the taking lens 800, although in which the illuminance in the perimeter is lowered by the effect of the printed regions 162a and 162b formed on the protection glass plate 160 and the sensor cover glass plate 162. Therefore, the image circles 851a, 851b, 851c, and 851d have overlapped portions.

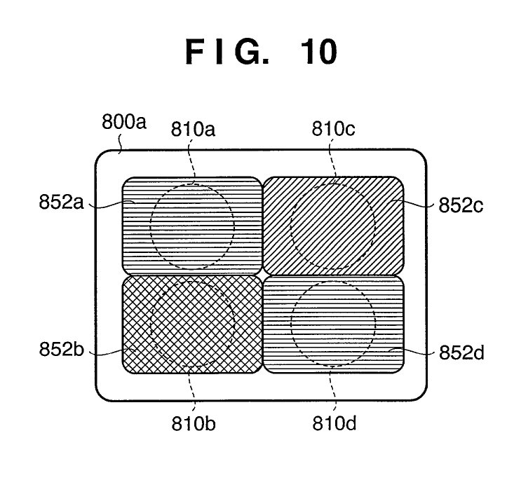

Referring back to FIG. 5, regions 852a and 852b sandwiched between the stop 810 and the taking lens 800 are optical filters formed on the light incident surface 800e of the taking lens 800. As shown in FIG. 10 in which the taking lens 800 is viewed from the light incident side, optical filters 852a, 852b, 852c, and 852d are formed to completely include the stop apertures 810a, 810b, 810c, and 810d, respectively.

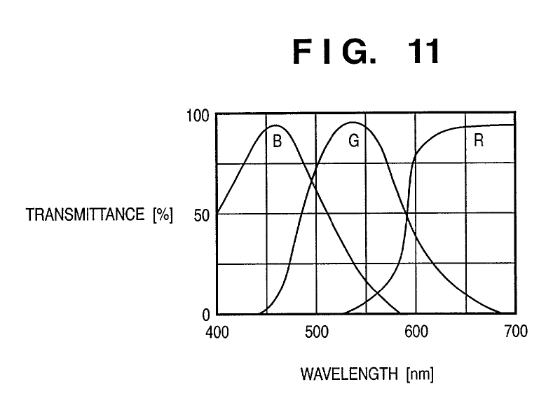

The optical filters 852a and 852d have a spectral transmittance characteristic, indicated by G in FIG. 11, which mainly transmits green. The optical filter 852b has a spectral transmittance characteristic, indicated by R, which principally transmits red. The optical filter 852c has a spectral transmittance characteristic, indicated by B, which mainly transmits blue. That is, these optical filters are primary-color filters. In accordance with the products of these spectral transmittance characteristics and the characteristics of the infrared cut filter formed in the lens portions 800a, 800b, 800c, and 800d, object images formed in the image circles 851a and 851d are obtained by a green light component, an object image formed in the image circle 851b is obtained by a red light component, and an object image formed in the image circle 851c is obtained by a blue light component.

By setting substantially the same focal length in the image forming systems at the representative wavelengths of their individual spectral distributions, a color image whose chromatic aberration is well corrected can be obtained by synthesizing these image signals. Achromatization for removing chromatic aberration usually requires a combination of at least two lenses differing in dispersion. In contrast, this arrangement in which each image forming system comprises a single lens achieves a remarkable cost down effect. This also contributes to the formation of a low-profile image sensing system.

Optical filters are also formed on the four image sensing regions 820a, 820b, 820c, and 820d of the solid-state image sensor 820. The image sensing regions 820a and 820d have the spectral transmittance characteristic indicated by G in FIG. 11. The image sensing region 820b has the spectral transmittance characteristic indicated by R in FIG. 11. The image sensing region 820c has the spectral transmittance characteristic indicated by B in FIG. 11. That is, the image sensing regions 820a and 820d are sensitive to green light (G), the image sensing region 820b is sensitive to red light (R), and the image sensing region 820c is sensitive to blue light (B).

The light receiving spectral distribution of each image sensing region is defined by the product of the spectral transmittance of the pupil and that of the image sensing region. Although the image circles overlap, therefore, a combination of the pupil of an image forming system and an image sensing region is substantially selected by the wavelength region.

In addition, microlenses 821 are formed on the image sensing regions 820a, 820b, 820c, and 820d in one-to-one correspondence with light receiving portions (e.g., 822a and 822b) of the individual pixels. These microlenses 821 are off-centered with respect to the light receiving portions of the solid-state image sensor 820. The off-center amount is zero in the centers of the image sensing regions 820a, 820b, 820c, and 820d and increases toward the perimeters. The off-center direction is the direction of a line segment connecting the center of each of the image sensing regions 820a, 820b, 820c, and 820d and each light receiving portion.

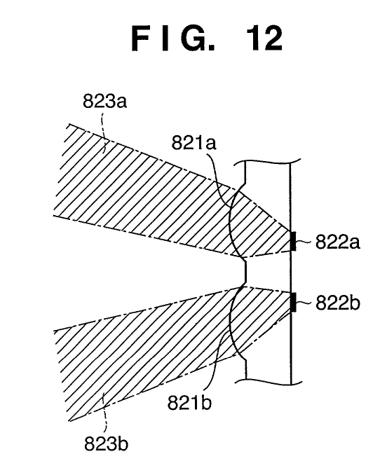

FIG. 12 is a view for explaining the function of this microlens 821. That is, FIG. 12 is an enlarged sectional view of the image sensing regions 820a and 820b and the light receiving portions 822a and 822b adjacent to each other.

A microlens 821a is off-centered upward in FIG. 12 with respect to the light receiving portion 822a. A microlens 821b is off-centered downward in FIG. 12 with respect to the light receiving portion 822b. As a result, a bundle of rays entering the light receiving portion 822a is restricted to a region 823a, and a bundle of rays entering the light receiving portion 822b is restricted to a region 823b.

These regions 823a and 823b of bundles of rays incline in opposite directions; the region 823a points in the direction of the lens portion 800a, and the region 823b points in the direction of the lens portion 800b. Accordingly, by appropriately selecting the off-center amount of each micro lens 821, only a bundle of rays output from a specific pupil enters each image sensing region. More specifically, the off-center amounts can be so set that object light passing the stop aperture 810a is photoelectrically converted principally in the image sensing region 820a, object light passing the stop aperture 810b is photoelectrically converted principally in the image sensing region 820b, object light passing the stop aperture 810c is photoelectrically converted principally in the image sensing region 820c, and object light passing the stop aperture 810d is photoelectrically converted principally in the image sensing region 820d.

In addition to the above-mentioned method of selectively allocating a pupil to each image sensing region by using the wavelength region, a method of selectively allocating a pupil to each image sensing region by using the microlenses 821 is applied. Furthermore, printing regions are formed on the protection glass plate 160 and the sensor cover glass plate 162. Consequently, crosstalk between wavelengths can be reliably prevented while the image circle overlapping is permitted. That is, object light passing the stop aperture 810a is photoelectrically converted in the image sensing region 820a, object light passing the stop aperture 810b is photoelectrically converted in the image sensing region 820b, object light passing the stop aperture 810c is photoelectrically converted in the image sensing region 820c, and object light passing the stop aperture 810dis photoelectrically converted in the image sensing region 820d. Accordingly, the image sensing regions 820a and 820d output a G image signal, the image sensing region 820b outputs an R image signal, and the image sensing region 820c outputs a B image signal.

An image processing system (not shown) forms a color image on the basis of the selective photoelectric conversion output that each of these image sensing regions of the solid-state image sensor 820 obtains from one of a plurality of object images. That is, this image processing system corrects the distortion of each image forming system by calculations, and performs signal processing for forming a color image on the basis of a G image signal containing a peak wavelength of 555 nm of the spectral luminous efficiency. Since G object images are formed in the two image sensing regions 820a and 820d, the number of pixels is twice that of the R or B image signal. Therefore, a high-resolution image can be obtained particularly in a wavelength region having high visual sensitivity. For this purpose, a method called pixel shift is used which increases the resolution by a few pixels by shifting object images in the image sensing regions 820a and 820d of the solid-state image sensor from each other by a ½ pixel upward, downward, to the left, and to the right. As shown in FIG. 9, object image centers 860a, 860b, 860c, and 860d which are also the centers of the image circles are offset a ¼ pixel in the directions of arrows 861a, 861b, 861c, and 861d from the centers of the image sensing regions 820a, 820b, 820c, and 820d, respectively, thereby achieving ½ pixel shift as a whole. Note that the length of the arrows 861a, 861b, 861c, and 861d does not indicate the offset amount.

When compared to an image sensing system using a single taking lens, the size of an object image obtained by this method is 1/24 compared to the Bayer arrangement method in which RGB color filters are formed using 2×2 pixels as one set on a solid-state image sensor, assuming that the pixel pitch of the solid-state image sensor is fixed. Accordingly, the focal length of the taking lens is shortened to approximately 1/\sqrt{4}=½. Hence, the method is extremely advantageous in forming a low-profile camera.

The positional relationship between the taking lens and the image sensing regions will be described next. As described previously, each image sensing region has dimensions of 1.248 mm×0.936 mm, and these image sensing regions are arranged with the separation band 0.156 mm in the horizontal direction and 0.468 mm in the vertical direction formed between them. The distance between the centers of adjacent image sensing regions is 1.404 mm in both the vertical and horizontal directions, and is 1.9856 mm in the diagonal direction.

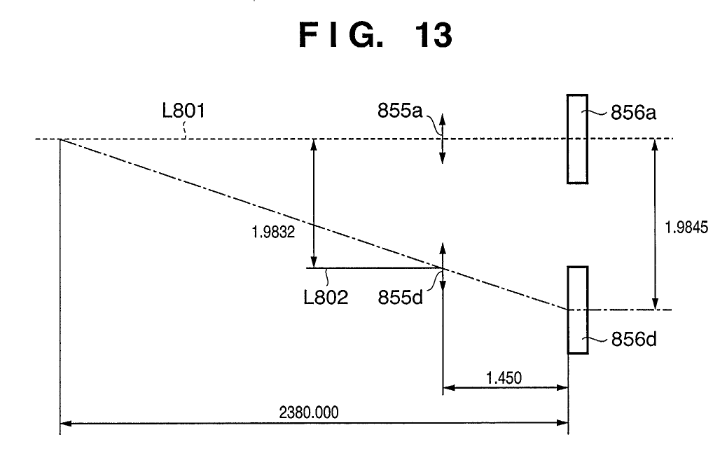

Assume that an image of an object at a reference object distance of 2.38 m is formed on image sensing portions of the image sensing regions 820a and 820d at an interval of 1.9845 mm which is obtained by subtracting the diagonal dimension of a ½ pixel from an image sensing region interval of 1.9856 mm, for the purpose of pixel shift. In this case, as shown in FIG. 13, the spacing between the lens portions 800a and 800d of the taking lens 800 is set to 1.9832 mm. Referring to FIG. 13, arrows 855a and 855d represent image forming systems with positive power formed by the lens portions 800a and 800d of the taking lens 800, respectively. Rectangles 856a and 856b represent the ranges of the image sensing regions 820a and 820d, respectively. L801 and L802 represent the optical axes of the image forming systems 855a and 855b, respectively. The light incident surface 800e of the taking lens 800 is a plane surface, and the lens portions 800a and 800b as the light exit surfaces are Fresnel lenses composed of concentric spherical surfaces. Therefore, a straight line passing through the center of the sphere and perpendicular to the light incident surface is the optical axis.

Next, the positional relationship between object images and image sensing regions and the positional relationship between pixels when object images are projected onto the object will be explained by reducing the number of pixels to 1/100 in both the vertical and horizontal directions for the sake of simplicity.

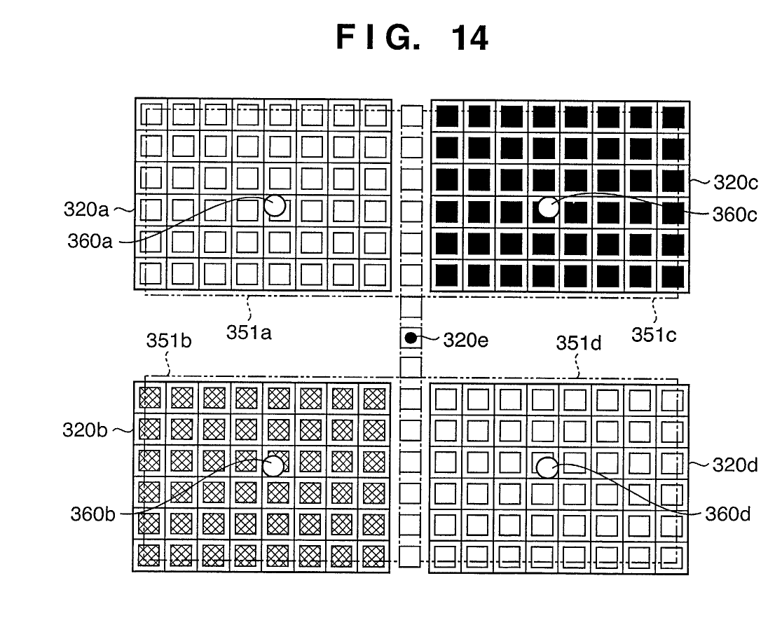

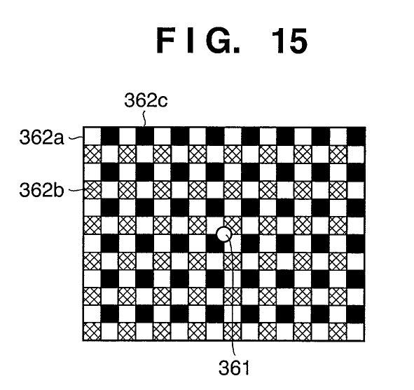

FIG. 14 is a view showing the positional relationship between object images and image sensing regions. FIG. 15 is a view showing the positional relationship between pixels when image sensing regions are projected onto an object.

Referring to FIG. 14, reference numerals 320a, 320b, 320c, and 320d denote four image sensing regions of the solid-state image sensor 820. For the sake of descriptive simplicity, assume that 8×6 pixels are arranged in each of these image sensing regions 320a, 320b, 320c, and 320d. The image sensing regions 320a and 320d output a G image signal, the image sensing region 320b outputs an R image signal, and the image sensing region 320c outputs a B image signal. Pixels in the image sensing regions 320a and 320d are indicated by blank squares. Pixels in the image sensing region 320b are indicated by hatched squares. Pixels in the image sensing region 320c are indicated by solid squares.

Between these image sensing regions, a separation band having a dimension equivalent to one pixel in the horizontal direction and a dimension equivalent to three pixels in the vertical direction is formed. Accordingly, the distances between the centers of the image sensing regions which output a G image are the same in the vertical and horizontal directions.

Referring to FIG. 14, reference numerals 351a, 351b, 351c, and 351d denote object images. For the purpose of pixel shift, centers 360a, 360b, 360c, and 360d of these object images 351a, 351b, 351c, and 351d are offset a ¼ pixel from the centers of the image sensing regions 320a, 320b, 320c, and 320d, respectively, toward the center of the whole image sensing region.

As a consequence, when these image sensing regions are inversely projected onto a plane at a predetermined distance on the object side, the result is as shown in FIG. 15. On the object side, the inversely projected images of the pixels in the image sensing regions 320a and 320d are indicated by blank squares 362a, the inversely projected images of the pixels in the image sensing region 320b are indicated by hatched squares 362b, and the inversely projected images of the pixels in the image sensing region 320c are indicated by solid squares 362c.

The inversely projected images of the centers 360a, 360b, 360c, and 360d of the object images overlap each other as a point 361, and the pixels in the image sensing regions 320a, 320b, 320c, and 320d are inversely projected such that the centers of these pixels do not overlap. The blank squares output a G image signal, the hatched squares output an R image signal, and the solid squares output a B image signal. Consequently, sampling equivalent to that of an image sensor having a Bayer arrangement type color filter is performed on the object.

The finder system will be described next. This finder system is made thin by using the properties of light by which light is totally reflected by the interface between a medium having a high refractive index and a medium having a low refractive index. An arrangement to be used in the air will be explained below.

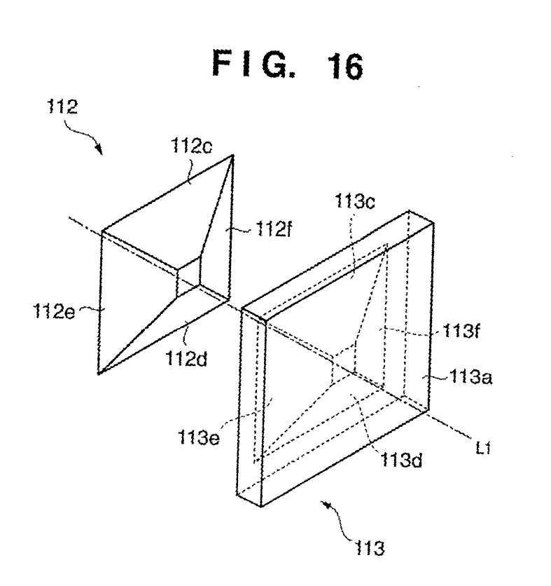

FIG. 16 is a perspective view of the first and second prisms 112 and 113 constructing the finder. The first prism 112 has four surfaces 112c, 112d, 112e, and 112f opposing a surface 112a. Object light entering from the surface 112a exits from the surfaces 112c, 112d, 112e, and 112f. Each of these surfaces 112a, 112c, 112d, 112e, and 112f is a plane surface.

The second prism 113 has surfaces 113c, 113d, 113e, and 113f opposing the surfaces 112c, 112d, 112e, and 112f, respectively, of the first prism 112. Object light entering from these surfaces 113c, 113d, 113e, and 113f exits from the surface 113a. The surfaces 112c, 112d, 112e, and 112f of the first prism 112 and the surfaces 113c, 113d, 113e, and 113f of the second prism 113 oppose each other via a slight air gap. Accordingly, the surfaces 113c, 113d, 113e, and 113f of the second prism 113 are also plane surfaces.

The finder system has no refractive force because it is necessary to allow a user to observe an object with his or her eye close to the finder. Since, therefore, the object light incident surface 112a of the first prism 112 is a plane surface, the object light exit surface 113a of the second prism 113 is also a plane surface. In addition, these surfaces are parallel to each other. Furthermore, the image sensing system 890 and the signal processing system form a rectangular image by total processing including distortion correction by calculations, so the observation field seen through the finder must also be a rectangle. Accordingly, the optically effective surfaces of the first and second prisms 112 and 113 are symmetrical with respect to plane in the vertical and horizontal directions. The line of intersection of two symmetric surfaces is a finder optical axis L1.

Object light entering from inside the observation field into the object light incident surface 112a of the first prism 112 passes through the air gap, and object light entering from outside the observation field into the object light incident surface 112a of the first prism 112 does not pass through the air gap. Consequently, a substantially rectangular finder field can be obtained as the total finder characteristic.

An outline of the configuration of the signal processing system will be described below.

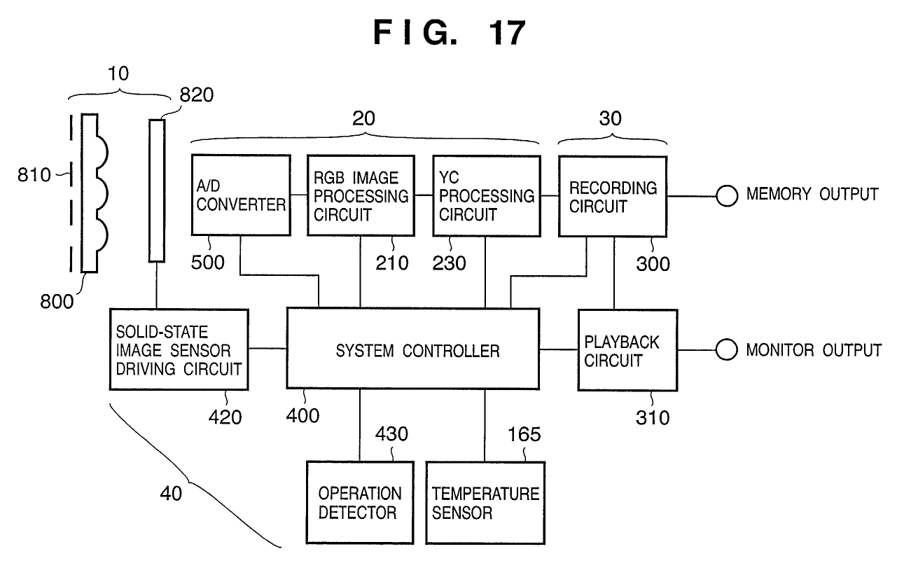

FIG. 17 is a block diagram of the signal processing system. This digital color camera 101 is a single-sensor digital color camera using the solid-state image sensor 820 such as a CCD or CMOS sensor. The digital color camera 101 obtains an image signal representing a moving image or still image by driving this solid-state image sensor 820 either continuously or discontinuously. The solid-state image sensor 820 is an image sensing device of a type which converts exposed light into electrical signals in units of pixels, stores electric charge corresponding to the light amount, and reads out the stored electric charge.

Note that FIG. 17 shows only portions directly connected to the present invention, so portions having no immediate connection with the present invention are not shown and a detailed description thereof will be omitted.

As shown in FIG. 17, this digital color camera 101 has an image sensing system 10, an image processing system 20, a recording/playback system 30, and a control system 40. The image sensing system 10 includes the taking lens 800, the stop 810, and the solid-state image sensor 820. The image processing system 20 includes an A/D converter 500, an RGB image processing circuit 210, and a YC processing circuit 230. The recording/playback system 30 includes a recording circuit 300 and a playback circuit 310. The control system 40 includes a system controller 400, an operation detector 430, the temperature sensor 165, and a solid-state image sensor driving circuit 420.

The image sensing system 10 is an optical processing system which forms an image of light from an object onto the image sensing surface of the solid-state image sensor 820 via the stop 810 and the taking lens 800. That is, this image sensing system 10 exposes an object image to the solid-state image sensor 820.

As described above, an image sensing device such as a CCD or CMOS sensor is effectively applied as the solid-state image sensor 820. By controlling the exposure time and exposure interval of this solid-state image sensor 820, it is possible to obtain an image signal representing a continuous moving image or an image signal representing a still image obtained by one-time exposure. Also, the solid-state image sensor 820 is an image sensing device having 800×600 pixels along the long and short sides, respectively, of each image sensing region, i.e., having a total of 1,920,000 pixels. On the front surface of this solid-state image sensor 820, optical filters of three primary colors, red (R), green (G), and blue (B), are arranged in units of predetermined regions.

An image signal read out from the solid-state image sensor 820 is supplied to the image processing system 20 via the A/D converter 500. For example, this A/D converter 500 is a signal conversion circuit which converts an image signal into, e.g., a 10-bit digital signal corresponding to the amplitude of a signal of each exposed pixel, and outputs the digital signal. The following image signal processing is executed by digital processing.

The image processing system 20 is a signal processing circuit which obtains an image signal of a desired format from R, G, and B digital signals. This image processing system 20 converts R, G, and B color signals into a YC signal represented by a luminance signal Y and color difference signals (R-Y) and (B-Y).

The RGB image processing circuit 210 is a signal processing circuit which processes an image signal of 800×600×4 pixels received from the solid-state image sensor 820 via the A/D converter 500. This RGB image processing circuit 210 has a white balance circuit, a gamma correction circuit, and an interpolation circuit which increases the resolution by interpolation.

The YC processing circuit 230 is a signal processing circuit which generates the luminance signal Y and the color difference signals R-Y and B-Y. This YC processing circuit 230 is composed of a high-frequency luminance signal generation circuit for generating a high-frequency luminance signal YH, a low-frequency luminance signal generation circuit for generating a low-frequency luminance signal YL, and a color difference signal generation circuit for generating the color difference signals R-Y and B-Y. The luminance signal Y is formed by synthesizing the high-frequency luminance signal YH and the low-frequency luminance signal YL.

The recording/playback system 30 is a processing system which outputs an image signal to a memory (not shown) and to a liquid crystal monitor (not shown). This recording/playback system 30 includes the recording circuit 300 for writing and reading image signals into and out from the memory, and the playback circuit 310 for playing back an image signal read out from the memory as a monitor output. More specifically, the recording circuit 300 includes a compressing/expanding circuit which compresses a YC signal representing still and moving images by a predetermined compression format, and expands compressed data when the data is read out.

This compressing/expanding circuit has a frame memory for signal processing. The compressing/expanding circuit stores a YC signal from the image processing system into this frame memory in units of frames, reads out the image signal in units of a plurality of blocks, and encodes the readout signal by compression. This compressing encoding is done by performing two-dimensional orthogonal transformation, normalization, and Huffman coding for an image signal of each block.

The playback circuit 310 converts the luminance signal Y and the color difference signals R-Y and B-Y into, e.g., an RGB signal by matrix conversion. A signal converted by this playback circuit 310 is output to the liquid crystal monitor, and a visual image is displayed.

The control system 40 includes control circuits for controlling the image sensing system 10, the image processing system 20, and the recording/playback system 30 in response to external operations. This control system 40 detects the pressing of the release button 106 and controls the driving of the solid-state image sensor 820, the operation of the RGB image processing circuit 210, and the compression process of the recording circuit 300. More specifically, the control system 40 includes the operation detector 430, the system controller 400, and the solid-state image sensor driving circuit 420. The operation detector 430 detects the operation of the release button 106. The system controller 400 controls the individual units in response to the detection signal from the operation detector 430, and generates and outputs timing signals for image sensing. The solid-state image sensor driving circuit 420 generates a driving signal for driving the solid-state image sensor 820 under the control of the system controller 400.

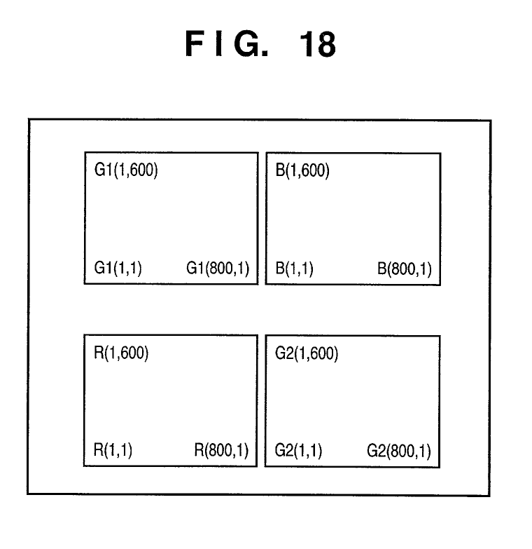

The operation of the solid-state image sensor driving circuit 420 will be described below. This solid-state image sensor driving circuit 420 controls the charge storage operation and charge read operation of the solid-state image sensor 820 such that the time-series sequence of output signals from the solid-state image sensor 820 is equivalent to that of a camera system using an image sensor having a Bayer type color filter arrangement. Image signals from the image sensing regions 820a, 820b, 820c, and 820d are G1(i,j), R(i,j), B(i,j), and G2(i,j), respectively, and the addresses are determined as shown in FIG. 18. Note that an explanation of the read of optical black pixels not directly related to final images will be omitted.

The solid-state image sensor driving circuit 420 starts reading from R(1,1) of the image sensing region 820b, proceeds to the image sensing region 820d to read out G2(1,1), returns to the image sensing region 820b to read out R(2,1), and proceeds to the image sensing region 820d to read out G2(2,1). After reading out R(800,1) and G2(800,1) in this manner, the solid-state image sensor 820 proceeds to the image sensing region 820a to read out G1(1,1), and proceeds to the image sensing region 820c to read out B(1,1), thereby reading out the first row of G1 and the first row of B. After reading out the first row of G1 and the first row of B, the solid-state image sensor driving circuit 420 returns to the image sensing region 820b to alternately read out the second row of R and the second row of G2. In this way, the solid-state image sensor driving circuit 420 reads out the 600th row of R and the 600th row of G2 to complete the output of all pixels.

Accordingly, the time-series sequence of the readout signals is R(1,1), G2(1,1), R(2,1), G2(2,1), R(3,1), G2(3,1), . . . , R(799,1), G2(799,1), R(800,1), G2(800,1), G1(1,1), B(1,1), G1(2,1), B(2,1), G1(3,1), B(3,1), . . . , G1(799,1), B(799,1), G1(800,1), B(800,1), R(1,2), G2(1,2), R(2,2), G2(2,2), R(3,2), G2(3,2), . . . , R(799,2), G2(799,2), R(800,2), G2(800,2), G1(1,2), B(1,2), G1(2,2), B(2,2), G1(3,2), B(3,2), . . . , G1(799,2), B(799,2), G1(800,2), B(800,2), . . . , R(1,600), G2(1,600), R(2,600), G2(2,600), R(3,600), G2(3,600), . . . , R(799,600), G2(799,600), R(800,600), G2(800,600), G1(1,600), B(1,600), G1(2,600), B(2,600), G1(3,600), B(3,600), . . . , G1(799,600), B(799,600), G1(800,600), B(800,600).

As described earlier, the same object image is projected onto the image sensing regions 820a, 820b, 820c, and 820d. Therefore, this time-series signal is completely equivalent to the result of read of an image sensor having a general Bayer type color filter arrangement, from an address (1,1) to an address (u,v), in an order indicated by the arrows.

Generally, a CMOS sensor has good random access properties with respect to individual pixels. Therefore, when the solid-state image sensor 820 is constructed by a CMOS sensor, it is very easy to read out stored electric charge in this order by applying the technique related to CMOS sensors disclosed in Japanese Patent Laid-Open No. 2000-184282. Also, a read method using a single output line has been explained in this embodiment. However, a read operation equivalent to a general two-line read operation can also be performed provided that random access is basically possible. The use of a plurality of output lines facilitates reading out high-speed signals. Accordingly, moving images having no unnaturalness in motion can be loaded.

The subsequent processing by the RGB image processing circuit 210 is as follows. RGB signals output from the R, G, and B regions via the A/D converter 500 are first subjected to predetermined white balance adjustment by the internal white balance circuit of the RGB image processing circuit 210. Additionally, the gamma correction circuit performs predetermined gamma correction. The internal interpolation circuit of the RGB image processing circuit 210 interpolates the image signals from the solid-state image sensor 820, generating an image signal having a resolution of 1,200×1,600 for each of R, G, and B. The interpolation circuit supplies these RGB signals to the subsequent high-frequency luminance signal generation circuit, low-frequency luminance signal generation circuit, and color difference signal generation circuit.

This interpolation process is to obtain high-resolution images by increasing the number of final output pixels. Practical contents of the process are as follows.

From image signals G1(i,j), G2(i,j), R(i,j), and B(i,j) each having a resolution of 600×800, the interpolation process generates a G image signal G′(m,n), an R image signal R′(m,n), and a B image signal B′(m,n) each having a resolution of 1,200×1,600.

Equations (1) to (12) below represent calculations for generating pixel outputs in positions having no data by averaging adjacent pixel outputs. This processing can be performed by either hardware logic or software.

(a) Generation of G′(m,n)

(i) When m: even number and n: odd number

G′ (m,n)=G2(m/2,(n+1)/2) (1)

(ii) When m: odd number and n: even number

G′ (m,n)=G1((m+1)/2,n/2) (2)

(iii) When m: even number and n: even number

G′ (m,n)=(G1(m/2,n/2)+G1(m/2+1,n/2)+G2(m/2,n/2)+G2(m/2,n/2+1))/4 (3)

(iv) When m: odd number and n: odd number

G′ (m,n)=(G1((m+1)/2,(n−1)/2)+G1((m+1)/2,(n−1)/(2+1)+G2((m−1)/2,(n+1)/2)+G2((m−1)/2+1, (n+1)/2))/4 (4)

(b) Generation of R′(m,n)

(v) When m: even number and n: odd number

R′(m,n)=(R(m/2,(n+1)/2)+R(m/2+1,(n+1)/2)/2 (5)

(vi) When m: odd number and n: even number

R′ (m,n)=(R((m+1)/2,n/2)+R((m+1)/2,n/2+1)/2 (6)

(vii) When m: even number and n: even number

R′(m,n)=(R(m/2,n/2)+R(m/2+1,n/2)+R(m/2,n/2+1)+R(m/2+1,n/2+1))/4 (7)

(viii) When m: odd number and n: odd number

R′(m,n)=R((m+1)/2,(n+1)/2) (8)

(c) Generation of B′(m,n)

(ix) When m: even number and n: odd number

B′ (m,n)=(B(m/2,(n−1)/2)+B(m/2,(n−1)/2+1))/2 (9)

(x) When m: odd number and n: even number

B′(m,n)=(B((m−1)/2,n/2)+B((m−1)/2+1,n/2))/2 (10)

(xi) When m: even number and n: even number

B′(m,n)=B(m/2,n/2) (11)

(xii) When m: odd number and n: odd number

R′(m,n)=(R(m/2,n/2)+R(m/2+1,n/2)+R(m/2,n/2+1)+R(m/2+1,n/2+1))/4 (12)

In this manner, the interpolation process forms a synthetic video signal based on output images from a plurality of image sensing regions. This digital color camera 101 is equivalent in the time-series sequence of sensor output signals to a camera system using an image sensor having a Bayer type filter arrangement. Accordingly, a general-purpose signal processing circuit can be used in the interpolation process. So, the circuit can be selected from various signal processing ICs and program modules having this function, and this is also very advantageous in cost.

Note that the subsequent luminance signal processing and color difference signal processing using G′(m,n), R′(m,n), and B′(m,n) are the same as those performed in normal digital color cameras.

Next, the operation of this digital color camera 101 will be explained.

During image sensing, the digital color camera is used with the contact protection cap 200 atta-ched to protect the connecting terminal 114 of the body of the digital color camera 101. When attached to the camera body 101, this contact protection cap 200 functions as a grip of the digital color camera 101 and facilitates holding this digital color camera 101.

First, when the main switch 105 is turned on, the power supply voltage is supplied to the individual components to make these components operable. Subsequently, whether an image signal can be recorded in the memory is checked. At the same time, the number of remaining frames is displayed on the display unit 150 in accordance with the residual capacity of the memory. An operator checks this display and, if image sensing is possible, points the camera in the direction of an object and presses the release button 106.

When the release button 106 is pressed halfway, the first-stage circuit of the switch 121 is closed, and the exposure time is calculated. When all the image sensing preparation processes are completed, image sensing can be performed at any time, and this information is displayed to the operator. When the operator presses the release button 106 to the limit accordingly, the second-stage circuit of the switch 121 is closed, and the operation detector (not shown) sends the detection signal to the system controller 400. The system controller 400 counts the passage of the exposure time calculated-beforehand and,-when the predetermined exposure time-has elapsed, supplies a timing signal to the solid-state image sensor driving circuit 420. The solid-state image sensor driving circuit 420 generates horizontal and vertical driving signals and reads out 800×600 pixels exposed in each of all the image sensing regions in accordance with the predetermined sequence described above. The operator holds the contact protection cap 200 and presses the release button 106 while putting the camera body 101 between the index finger and thumb of the right hand (FIG. 3). A projection 106a is formed integrally with the release button 106 on the central line L2 of the axis of the release button 106. Additionally, the projection 120 is formed in that position on the rear cover 125, which is extended from the central line L2. Therefore, the operator uses these two projections 106a and 120 and performs the release operation by pushing the projection 106a with the index finger and the projection 120 with the thumb. This can readily prevent the generation of couple of forces shown in FIG. 3, so high-quality images having no blur can be sensed.

The readout pixels are converted into digital signals having a predetermined bit value by the A/D converter 500 and sequentially supplied to the RGB image processing circuit 210 of the image processing system 20. The RGB image processing circuit 210 performs white balance correction, gamma correction, and pixel interpolation for these signals, and supplies the signals to the YC processing circuit 230.

In the YC processing circuit 230, the high-frequency luminance signal generation circuit generates a high-frequency luminance signal YH for R, G, and B pixels, and the low-frequency luminance signal generation circuit generates a low-frequency luminance signal YL. The high-frequency luminance signal YH as a result of calculations is output to an adder via a low-pass filter. Likewise, the low-frequency luminance signal YL is output to the adder through the low-pass filter by subtracting the high-frequency luminance signal YH. Consequently, the difference (YL−YH) between the high- and low-frequency luminance signals YH and YL is added to obtain a luminance signal Y. Similarly, the color difference signal generation circuit calculates and outputs color difference signals R-Y and B-Y. The output color difference signals R-Y and B-Y are passed through the low-pass filter, and the residual components are supplied to the recording circuit 300.

Upon receiving the YC signal, the recording circuit 300 compresses the luminance signal Y and the color difference signals R-Y and B-Y by a predetermined still image compression scheme, and sequentially records these signals into the memory. To play-back a still image or moving image from the image signal recorded in the memory, the operator presses the play button 9. Accordingly, the operation detector 430 detects this operation and supplies the detection signal to the system controller 400, thereby driving the recording circuit 300. The recording circuit 300 thus driven reads out the recorded contents from the memory and displays the image on the liquid crystal monitor. The operators selects a desired image by, e.g., pressing the select button.

In this embodiment as described above, the digital color camera 101 has a plurality of image sensing units for receiving light from an object through different apertures. These image sensing units are so arranged that images of an object at a predetermined distance are received as they are shifted a predetermined amount from each other in at least the vertical direction. This makes it possible to increase the number of final output pixels and obtain a high-resolution image.

Additionally, the image sensing units are so arranged that images of an object at a predetermined distance are received as they are shifted a predetermined amount from each other in the horizontal direction. This also makes it possible to increase the number of final output pixels and obtain a high-resolution image.

Furthermore, the number of the image sensing units is at least three, so the three primary colors of light can be received.

Also, the image sensing units are area sensors by which images of an object at a predetermined distance are received as they are shifted at a pitch of a 1/2 pixel in the vertical direction. Accordingly, it is possible to increase the number of final output pixels and obtain a high-resolution image.

Furthermore, the image sensing units are area sensors by which images of an object at a predetermined distance are received as they are shifted at a pitch of a ½ pixel in the horizontal direction. Therefore, it is possible to increase the number of final output pixels and obtain a high-resolution image.

(Second Embodiment)

In the above first embodiment, the four image sensing regions are arranged such that each image sensing region is a combination of 2×2 of R·G2 and G1·B, like pixel units of the Bayer arrangement. However, the present invention is not limited to this embodiment provided that object images obtained by four image forming systems and image sensing regions have a predetermined positional relationship. In this embodiment, therefore, other examples of the positional relationship between object images and image sensing regions will be explained.

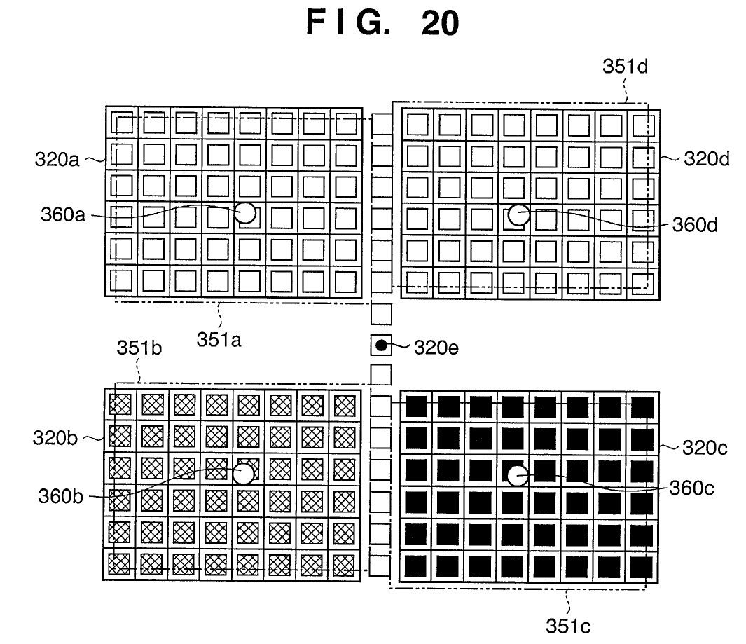

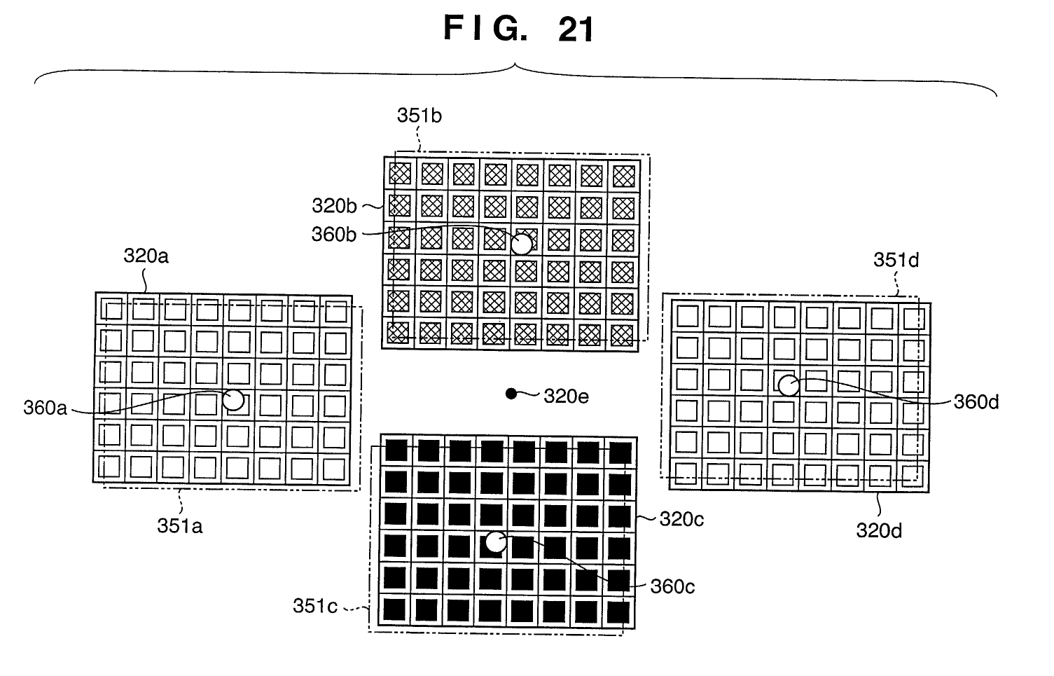

FIGS. 20 and 21 are views for explaining other examples of the positional relationship between object images and image sensing regions.

The arrangement of image sensing regions is changed from that shown in FIG. 14 while the positional relationship between each image sensing region and an object image shown in FIG. 14 is held. That is, although the arrangement is 2×2 of R·G2 and G1·B in the first embodiment, this arrangement shown in FIG. 20 is 2×2 of R·B and G1·G2. The positional relationship between centers 360a, 360b, 360c, and 360d of object images and image sensing regions 320a, 320b, 320c, and 320d remains unchanged. FIG. 21 shows a cross-shaped arrangement of G1·R·B·G2. As in the former arrangement, the positional relationship between the object image centers 360a, 360b, 360c, and 360d and the image sensing regions 320a, 320b, 320c, and 320d remains the same.

In either form, the time-series sequence of readout signals is R(1,1), G2(1,1), R(2,1), G2(2,1), R(3,1), G2(3,1), . . . , R(799,1), G2(799,1), R(800,1), G2(800,1), G1(1,1), B(1,1), G1(2,1), B(2,1), G1(3,1), B(3,1), . . . , G1(799,1), B(799,1), G1(800,1), B(800,1), R(1,2), G2(1,2), R(2,2), G2(2,2), R(3,2), G2(3,2), . . . , R(799,2), G2(799,2), R(800,2), G2(800,2), G1(1,2), B(1,2), G1(2,2), B(2,2), G1(3,2), B(3,2), . . . , G1(799,2), B(799,2), G1(800,2), B(800,2), . . . , R(1,600), G2(1,600), R(2,600), G2(2,600), R(3,600), G2(3,600), . . . , R(799,600), G2(799,600), R(800,600), G2(800,600), G1(1,600), B(1,600), G1(2,600), B(2,600), G1(3,600), B(3,600), . . . , G1(799,600), B(799,600), G1(800,600), B(800,600).

By setting this signal output sequence and using the optical arrangement as described above, the embodiment is exactly equivalent in both space and time series to an image sensor having a general Bayer type color filter arrangement.

The embodiment also achieves the same effect as the first embodiment described above. In each of the first and second embodiments, pixel shift is done by shifting the optical axis of the image sensing system. Therefore, all pixels configuring the four image sensing regions can be arranged on lattice points at fixed pitches in both the vertical and horizontal directions. This can simplify the design and structure of the solid-state image sensor 820. Additionally, signal output equivalent to that when four image sensing regions are separated can be performed by using a solid-state image sensor having one image sensing region and applying the function of random access to pixels. In this case, a multi-lens, thin-profile image sensing system can be realized by using a general-purpose, solid-state image sensor.

In this embodiment as described in detail above, an image sensing apparatus has a plurality of image sensing units for receiving an object image via different apertures, and these image sensing units are so arranged that images of an object at a predetermined distance are received as they are shifted a predetermined amount from each other in at least the vertical direction. This makes it possible to increase the number of final output pixels and obtain a high-resolution image.

Additionally, the image sensing units are so arranged that images of an object at a predetermined distance are received as they are shifted a predetermined amount from each other in the horizontal direction. This also makes it possible to increase the number of final output pixels and obtain a high-resolution image.

Furthermore, the number of the image sensing units is at least three, so the three primary colors of light can be received.

Also, the image sensing units are area sensors by which images of an object at a predetermined distance are received as they are shifted at a pitch of a ½ pixel in the vertical direction. Accordingly, it is possible to increase the number of final output pixels and obtain a high-resolution image.

Furthermore, the image sensing units are area sensors by which images of an object at a predetermined distance are received as they are shifted at a pitch of a ½ pixel in the horizontal direction. Therefore, it is possible to increase the number of final output pixels and obtain a high-resolution image.

The present invention is not limited to the above embodiments and various changes and modifications can be made within the spirit and scope of the present invention. Therefore, to apprise the public of the scope of the present invention the following claims are made.

What is claimed is:

1. An image sensing apparatus comprising a plurality of image sensing units for receiving an object image via different apertures,
wherein said plurality of image sensing units are arranged such that images of an object at a predetermined distance are received as they are shifted a predetermined amount from each other in at least the vertical direction, and
wherein said plurality of image sensing units have filters having different spectral transmittance characteristics.

2. The apparatus according to claim 1, further comprising a plurality of image forming optical--systems for forming images of object light, entering via said different apertures, onto said plurality of image sensing units.

3. The apparatus according to claim 1, wherein said plurality of image sensing units are arranged such that images of an object at a predetermined distance are received as they are shifted a predetermined amount from each other in the horizontal direction.

4. The apparatus according to claim 1, wherein said plurality of image sensing units are at least three image sensing units.

5. The apparatus according to claim 1, wherein said plurality of image sensing units are at least three image sensing units which receive object images via said filters having different spectral transmittance characteristics.

6. The apparatus according to claim 1, wherein said plurality of image sensing units are at least three image sensing units which receive object images via filters having green, red, and blue spectral transmittance characteristics.

7. The apparatus according to claim 1, wherein said plurality of image sensing units are formed on the same plane.

8. The apparatus according to claim 1, wherein said plurality of image sensing units are area sensors by which images of an object at the predetermined distance are received as they are shifted at a pitch of a ½ pixel in the vertical direction.

9. The apparatus according to claim 4, wherein said plurality of image sensing units are area sensors by which images of an object at the predetermined distance are received as they are shifted at a pitch of a ½ pixel in the horizontal direction.
